(19) United States
(12) Patent Application Publication
(10) Pub. No.: US 2021/0323879 A1
(43) Pub. Date: Oct. 21, 2021

(54) NANO-MODIFIED MATERIAL FOR CAVITY WALL WITH INSULATION FOR PREFABRICATED BUILDING, AND PREPARATION METHOD AND USE THEREOF

(71) Applicant: QINGDAO UNIVERSITY OF TECHNOLOGY, Qingdao, Shandong (CN)

(72) Inventors: Jianlin LUO, Qingdao (CN); Qiuyi LI, Qingdao (CN); Chao LIU, Qingdao (CN); Shaochun LI, Qingdao (CN); Song GAO, Qingdao (CN); Xueqing ZHU, Qingdao (CN)

(73) Assignee: QINGDAO UNIVERSITY OF TECHNOLOGY, Qingdao, Shandong (CN)

(21) Appl. No.: 17/268,290

(22) PCT Filed: Apr. 30, 2020
(86) PCT No.: PCT/CN2020/088112

§ 371 Date: Feb. 12, 2021

(30) Foreign Application Priority Data
Jul. 17, 2019 (CN) 201910645733.3

(51) Int. Cl. C04B 38/10; E04C 2/04; E04C 2/288; E04B 2/00; C04B 28/04; C04B 41/64; C04B 41/00

(52) U.S. Cl. CPC C04B 38/10; E04C 2/049; E04C 2/2885; E04B 2/8605; C04B 28/04; C04B 41/64; C04B 41/009; E04C 2/46

(57) ABSTRACT

A nano-modified material for cavity wall with insulation for prefabricated building, preparation method and application thereof, belonging to the technical field of building materials. The material includes splicing structures and a nano-modified silane waterproof coating, wherein the splicing structure includes a recycled concrete structure layer and a nano-modified foam concrete thermal insulation core layer, the recycled concrete structure layer is a hollow cuboid structure with openings at both ends, the nano-modified foam concrete thermal insulation core layer is a structure formed by casting inside the recycled concrete structure layer, and the nano-modified silane waterproof coating is applied at a butt joint of two of the splicing structures.

### CROSS-REFERENCE TO RELATED APPLICATION

This disclosure claims the priority of Chinese Patent Application No. 201910645733.3 filed on Jul. 17, 2019, the entire contents of which are incorporated herein by reference.

### TECHNOLOGY FIELD

The present disclosure relates to the technical field of building materials, in particular to a nano-modified material for cavity wall with insulation for prefabricated building, and a preparation method and use thereof.

### BACKGROUND

The unprecedented rapid development of the construction industry consumes a large number of building materials, resulting in: (1) the increasing shortage of building raw materials, causing serious pollution to the natural environment; and (2) that human demolition and earthquake and other natural disasters cause a large number of buildings to be destroyed, resulting in the increasing number of construction waste.

With the development of modern industrial technology, the prefabricated buildings with high construction speed, small constraints by climate conditions, ability for labor saving and improving the quality of buildings have emerged. As an important component of prefabricated building, the wall often needs to have the comprehensive performances of light weight, high strength, heat preservation and insulation, and being moisture-resistant and moisture-proof. The steam-cured or cast-in-place cement foam wall panels, which are made of cement combined foaming agent, are widely concerned because of light weight, being inorganic, flame retardancy, the same service life as the structure and low cost thereof.

However, there are still the following problems. (1) Foaming concrete products often have the disadvantages of poor slurry stability, easy to collapse in mold, low strength, and easy to shrink and crack on the surface. (2) In the inorganic thermal insulation layer of wall material structure, there are common problems such as high porosity and high water absorption. (3) It is hard to realize the comprehensive application of construction waste in the wall material system, and thereby the green utilization rate is low. At present, there is still no technical solution, which may achieve a comprehensive application effect that may increase the foam stability of the sandwiched layer and enhance the interface bond with the recycled concrete base at the same time in the fabricated building wall structure, reduce the water absorption of the wall surface effectively, and recycle the construction waste.

### SUMMARY

In one aspect, the present disclosure provides a nano-modified material for cavity wall with insulation for prefabricated building, comprises splicing structures and a nano-modified silane waterproof coating, wherein the splicing structure comprises a recycled concrete structure layer and a nano-modified foam concrete thermal insulation core layer, the recycled concrete structure layer is a hollow cuboid structure with openings at both ends, the nano-modified foam concrete thermal insulation core layer is a structure formed by casting inside the recycled concrete structure layer, and the nano-modified silane waterproof coating is applied at a butt joint of two of the splicing structures;

wherein the recycled concrete structure layer comprises following components: a cement, a recycled coarse aggregate, a recycled fine aggregate, a recycled micro powder, a water reducing agent, and water, and a mass ratio of respective components is 1:(1-3.5):(1-L5):(0-0.05):(0.005-0.05):(0.25-0.55);

wherein the nano-modified foam concrete thermal insulation core layer comprises following components: an expansive cement, a foam obtained by foaming of a foaming fluid formulated at a standard concentration, a nanomaterial-containing nanomaterial aqueous dispersing fluid, a surfactant, and water, and a mass ratio of respective components is 1:(0.05-0.25):(0.01-0.05):(0.001-0.01):(0.3-0.5), and a mass ratio of the nanomaterial aqueous dispersing fluid to the nanomaterial is (0.01-0.05): (0.001-0.01); and

wherein the nano-modified silane waterproof coating comprises following components: a silane monomer, an emulsifier, a mixed medium of ethanol and water, and a nanomaterial sol, and a mass ratio of respective components is 1:(0.1-0.15):(0.25-0.55):(1-3.5).

Optionally, a mass ratio of the recycled concrete structure layer, the nano-modified foam concrete thermal insulation core layer and the nano-modified silane waterproof coating is 100:(5-10):(0.01-0.1).

Optionally, the nominal particle sizes of the recycled coarse aggregate and the recycled fine aggregate are 0.6 mm-4.75 mm, 5 mm-26.5 mm, respectively. The nominal maximal particle size of the recycled micro powder does not exceed 0.6 mm.

Optionally, the cement is a Portland cement, an ordinary Portland cement or a composite cement; the water reducing agent is a polycarboxylic acid-based water reducing agent, a naphthalene-based sodium sulfonate water reducing agent or a melamine resin-based water reducing agent; the expansive cement is one of a sulphoaluminate-based expansive cement, an aluminate-based expansive cement and a silicate-based expansive cement; the foaming fluid is one of an animal protein foaming agent, a plant protein foaming agent, a chemical foaming agent and a composite foaming agent; the nanomaterial is one of nano-SiO₂, nano-TiO₂, nano-ZnO, nano-Fe₂O₃, nano-CaCO₃, carbon nanotubes and graphene oxide; and the surfactant is one of sodium dodecylbenzene sulfonate, cetyltrimethylammonium bromide, sodium polyacrylate, sodium p-styrenesulfonate and N-methylpyrrolidone.

Optionally, the silane monomer is methyltriethoxysilane, propyltrimethoxysilane, isobutyl siloxane, hexamethyldisiloxane or cyclomethylsiloxane; the emulsifier is polyoxyethylene alkylphenyl ether, polyoxyethylene trimethylnonyl ether copolymer or polyoxyethylene octylphenol ether; a mass ratio of ethanol and water is (0.4-0.6):1 in the mixed medium of ethanol and water; and a mass ratio of the nanomaterial to the nanomaterial sol is (0.05-0.2):1 in the nanomaterial sol.

The disclosure also provides a preparation method of the above-mentioned nano-modified material for cavity wall with insulation for prefabricated building, comprising following steps:

S1 Preparation of the Recycled Concrete Structure Layer:
S11: dissolving the water reducing agent in a part of the water, to form a water reducing agent solution;
S12: mixing the cement, the recycled coarse aggregate, the recycled fine aggregate, the recycled micro powder and remaining water mechanically, to form a mixture;
S13: adding the water reducing agent solution to the mixture, and further stirring the mixture, to form a recycled concrete slurry;
S14: casting the recycled concrete slurry into a special mold for prefabricated wall panel structural layer, and obtaining the hollow recycled concrete structural layer by steam curing and molding and demolding;

S2 Preparation of the Nano-Modified Foam Concrete Thermal Insulation Core Layer:
S21: dispersing the nanomaterial and the surfactant in water by using an ultrasonic surfactant synergic dispersing process, to form an aqueous dispersion of nanomaterial;
S22: mixing the expansive cement, the aqueous dispersion of nanomaterial and water sufficiently uniformly, to form a nano-modified cement slurry; meanwhile, obtaining the foam by foaming of a foaming fluid formulated at a standard concentration with a physical foaming method;
S23: mixing uniformly the nano-modified cement slurry and the foam uniformly, to obtain a nano-modified foam concrete slurry by a foam concrete mixer, which may effectively reduce the breaking phenomena of foam during the stirring and homogenizing;
S24: pumping the nano-modified foam concrete slurry to a hollow inner core layer of the recycled concrete structure layer by a foam concrete pumping equipment, and performing curing and molding, to obtain the nano-modified foam concrete insulation core layer, to obtain the splicing structure;

S3 Preparation of the Nano-Modified Silane Waterproof Coating:
S31: preparing the nanomaterial sol;
S32: preparing a silane polymer sol from the silane monomer, the emulsifier, ethanol and water, mixing the nanomaterial sol with the silane polymer sol to form a composite sol system, in which nano-modified silane is formed by modifying a surface of the nanomaterial by silane polymer;
S33: splicing two splicing structures prepared in S2, and applying nano-modified silane at the butt joint, and forming the nano-modified silane waterproof coating by curing.

Optionally, in step S14, the special mold for prefabricated wall panel structural layer is a hollow cuboid steel mold equipped with a reinforcing steel bar mesh, and is characterized by being double-layer hollow, wherein an inner hollow cuboid steel mold is nested in an outer hollow cuboid steel mold, and the recycled concrete slurry is casted into the outer hollow cuboid steel mold equipped with the reinforcing mesh, and the inner hollow cuboid steel mold is removed, to form the hollow recycled concrete structure layer; wherein the recycled concrete structure layer has an inner height of 60-120 mm, an outer height of 180-240 mm, an inner width of 550-850 mm, an outer width of 600-900 mm, and a length of 1350-2400 mm.

Optionally, the special mold for prefabricated wall panel structural layer is provided with “convex concave” female-male connection ends.

Optionally, in step S23, a mass ratio of the nano-modified cement slurry to the foam is 1:(0.03-0.17) in the nano-modified foam concrete slurry.

Optionally, in step S33, the nano-modified silane waterproof coating layer is formed by performing coating 1-5 times, and a thickness formed by coating at each time is 50 μm-1000 μm.

Additionally, the disclosure also provides use of a nano-modified material for cavity wall with insulation for prefabricated building, wherein the nano-modified material for cavity wall with insulation for prefabricated building is used as a structure-thermal insulation-integrated wall for a prefabricated building.

### DESCRIPTION OF DRAWINGS

In order to more clearly explain the embodiments of the present disclosure or the technical solutions in the prior art, a brief introduction will be given to the drawings needed in the description of embodiments or the prior art below. It is obvious to those skilled in the art that other drawings may be obtained according to these drawings without any inventive labor.

FIG. 1 is the schematic diagram of the structure of the nano-modified material for cavity wall with insulation for the prefabricated building of the present disclosure.

FIG. 2 is a SEM image of nano-modified foam concrete thermal insulation core layer of the present disclosure.

FIG. 3 is a SEM image of foam concrete based on ordinary Portland cement.

FIG. 4 is a schematic drawing of an embodiment of the mold used in the present disclosure.

### EMBODIMENTS

In view of the above shortcomings of the prior art, the present disclosure provides a nano-modified material for cavity wall with insulation for prefabricated building, which may not only guarantee the light weight and heat preservation of the core layer and the interface adhesion with the base surface, avoid the problem that the surface of the existing wall panel is easy to shrink and crack, and reduce the surface water absorption of the wall material greatly, but also effectively realize the recycling of construction waste, which possesses huge economic and environmental benefits.

In order to enable those skilled in the art to understand the technical solution in the present disclosure better, the technical solution in the embodiment of the present disclosure will be described clearly and completely in combination with the drawings in the embodiment of the present disclosure. Obviously, the described embodiment is only a part of the embodiment of the present disclosure, not all of the embodiments. Based on the embodiments in the present disclosure, all other embodiments obtained by those skilled in the art without creative labor shall belong to the scope of protection of the present disclosure.

FIG. 1 is the schematic diagram of the structure of the nano-modified material for cavity wall with insulation for the prefabricated building of the present disclosure. In the figures, 1 represents a recycled concrete structure layer, 11 represents recycled aggregates for recycled concrete, 12 represents a steel wire mesh embedded in recycled concrete; 2 represents a nano-modified foam concrete thermal insulation core layer, 22 represents microbubbles containing nanomaterial nucleating agents; 3 represents a nano-modified silane waterproof coating; 31 represents a nanomaterial-modified silane chain; 4 represents a male-female convex concave connection fastener.

Among them, steel wire mesh embedded in recycled aggregate concrete and recycled concrete are components of the recycled concrete structure layer. Microbubbles containing nanomaterial nucleating agents are a component in the nano-modified foam concrete thermal insulation core layer. Nanomaterial-modified silane chain is a component of the nano-modified silane waterproof coating. The aggregates for recycled concrete include recycled coarse aggregate and recycled fine aggregate. The steel wire mesh embedded in recycled concrete is for improving the strength and rigidity of the recycled concrete structure layer, which is also a common measure familiar to those skilled in concrete structure in the art. The term microbubbles containing nanomaterial nucleating agent is to schematically show the nucleation effect of nanomaterial on the bubbles in expansive cement. The term nanomaterial-modified silane chain is to simply indicate the main components in the nano-modified silane waterproof coating, so as to facilitate better understanding by those skilled in the art.

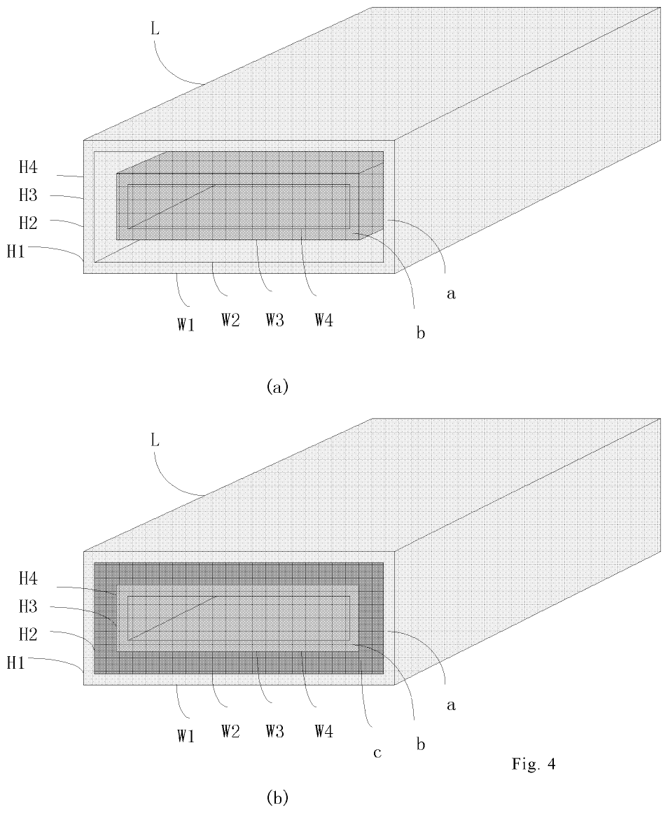

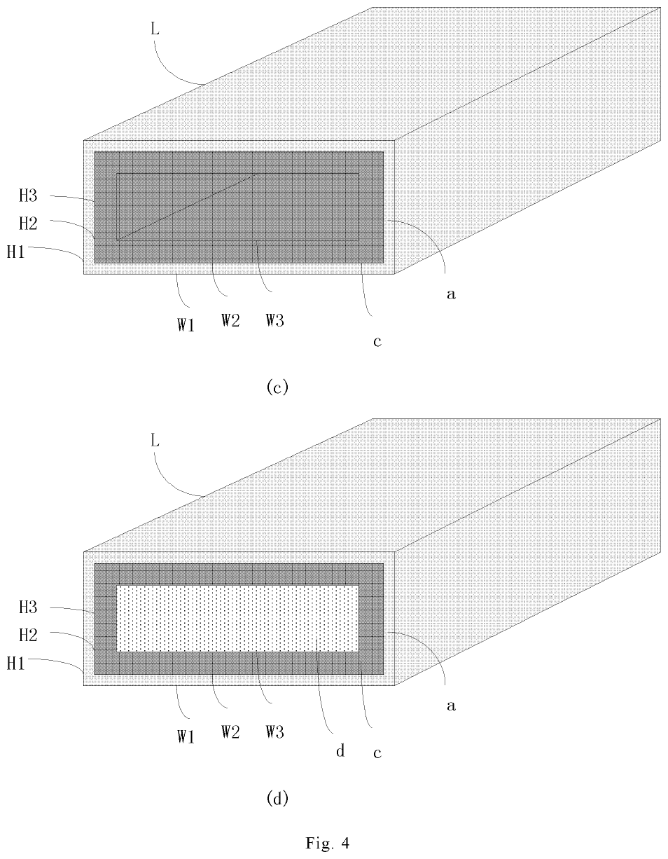

FIG. 4 shows a steel mold for producing the wall panel of the present disclosure. As shown in FIG. 4(a), the steel mold has a double-layer style, and has an outer layer a and an inner layer b. The inner and outer layers of the steel mold both have a length L. The outer layer of the steel has an outer width and an inner width of W1 and W2, and an outer height and an inner height of H1 and H2, respectively. The inner layer of the steel has an outer width and an inner width of W3 and W4, and an outer height and an inner height of H3 and H4, respectively. When the mold is used, recycled concrete slurry is first cast between the inner and outer layers of the steel mold, and a recycled concrete structure layer c is formed after curing and molding, wherein it may have an outer width and an inner width of W2 and W3, and an outer height and an inner height of H2 and H3, respectively, as shown in FIG. 4(b). Then the inner layer of the steel mold is drawn out from the recycled concrete structure layer c (i.e.demolding), as shown in FIG. 4(c). Optionally, the outer mold may also be removed. Finally, the nano-modified foam concrete thermal insulation core layer d is formed by casting in the hollow inner core layer of the recycled concrete structure layer c. The resultant nano-modified foam concrete thermal insulation core layer may have a width and a height of W3 and H3, respectively, as shown in FIG. 4(d). However, the sizes of the recycled concrete structure layer c and the nano-modified foam concrete thermal insulation core layer d may also change after the curing process. The size of the steel mold may be selected appropriately, according to the desired wall panel final product and specific processes.

A process for synergically dispersing the surfactant may be incorporated in the step S21. In step S23, using foam concrete mixer may effectively reduce the burst of foam during blending. In the step S24, the curing period may be 3d, and the foam concrete pumping equipment may transport the slurry to a desired region uniformly, and avoid collapse of the foam in the nano-modified foam concrete caused by a large drop in level. In S31, methods such as a sol-gel method or a hydrothermal method, which are well known by those skilled in the art, may be used to prepare the nanomaterial sol. In the step 32, the silane polymer sol may be prepared by reactions, such as hydrolysis and condensation of the silane monomer, which are well known by those skilled in the art, and the nanomaterial sol may be mixed with the silane polymer sol to form a composite sol system by a self-assembly method well known by those skilled in the art. In the step 33, the nano-modified silane may be applied by methods such as a screen printing method or a roller coating method, which are well known by those skilled in the art. Further, the number of coating and the thicknesses thereof may be determined by different application conditions.

Firstly, concrete demolished from the reinforced concrete base building was collected, classified and processed, crushed and granulated, by the technologies familiar in the field, and thereby recycled coarse aggregate and recycled fine aggregate with particle size of 0.6 mm-4.75 mm and 5 mm-26.5 mm, and recycled micro powder with nominal maximal particle size of no more than 0.6 mm were respectively produced.

The “convex concave” female-male connection ends, which are well known by those skilled in the art in a width direction, are beneficial for tight connection. The female-male convex-concave connection fasteners are used for connecting the wall panels, so that disassembly is convenient and the reuse ratio is high.

### Example 1

The specific steps of the preparation process of the nano-modified material for cavity wall with insulation for prefabricated building in this example are as follows.

S1 Preparation of a Recycled Concrete Structure Layer

S11: 4.2 kg of polycarboxylic acid-based water reducing agent was dissolved in 45 kg of water to form a water reducing agent solution.

S12: 350 kg of P.O. 42.5R ordinary Portland cement, 1115 kg of recycled coarse aggregate, 525 kg of recycled fine aggregate and 17.5 kg of recycled micro powder are mechanically homogenized according to the Technical Standard for Recycled Concrete Structure (JGJ/T 443-2018) (China), and then 100 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, and demolding was performed after 18 h, and curing by steam was performed for 7d, to obtain a recycled concrete structure layer, which has a size of 1850 mm×750 mm (inner width 660 mm)×180 mm (inner height 90 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 500 g of nano-SiO₂ (average particle size: 120 nm) and 200 g of sodium dodecylbenzene sulfonate were added into 5 kg of water, and then they were processed with a bath-type ultrasonic processor for 2 h (80 W, ultrasonic method: pausing for 10 s every 90 s of ultrasonic processing), to form a nano-SiO₂ aqueous dispersion.

S22: 100 kg of sulphoaluminate-based expansive cement, 5 kg of nano-SiO₂ aqueous dispersion and 45 kg of water were fully homogenized, to form a nano-modified cement slurry. Meanwhile, 1 kg of animal protein-based foaming fluid was dissolved in 10 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A nano-SiO₂ sol was prepared by a sol-gel method, wherein the mass ratio of nano-SiO₂ to the nano-SiO₂ sol was 0.2:1.

S32: 1 kg of methyltriethoxysilane was dissolve in 550 g of a mixed medium of ethanol and water (mass ratio of ethanol to water: 0.4:1). Under catalysis of 50 g of acetic acid and action of 150 g of polyoxyethylene alkylphenyl ether emulsifier, a semitransparent viscous silane polymer sol was formed. Then 1 kg of the nano-SiO₂ sol was mixed with the silane polymer sol by a self-assembly technology to form a composite sol system, so as to form a nano-modified silane.

S33: Two structures for splicing prepared in S2 were spliced by a roll coating method. 3 layers of the nano-modified silane composite sol with a thickness of 850 μm were coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 43.7±5.89 MPa and 0.126±0.009 MPa, respectively. The flexural strength in a three-point-bend test and mid span bending deformation of the reinforced wall of the recycled concrete structure layer were measured by a large-sized test machine. They were 21.57 MPa and 8.58 mm, respectively. The contact angle, dry density, 72h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 65.41°, 311.3 kg/m³, 45.2%, 0.61 MPa and 0.0791 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 125.87° and 7.7%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which met the requirements of the specification, and effectively achieves the effect of recycling of total components of construction waste.

### Example 2

The specific steps of the preparation process of the nano-modified material for cavity wall with insulation for prefabricated building in this Example are as follows.

S1 Preparation of a Recycled Concrete Structure Layer

S11: 17.5 kg of sodium naphthalene sulfonate water reducing agent was dissolved in 92.5 kg of water to form a water reducing agent solution.

S12: 350 kg of composite Portland cement, 700 kg of recycled coarse aggregate, 350 kg of recycled fine aggregate and 17.5 kg of recycled micro powder are mechanically homogenized according to the Technical Standard for Recycled Concrete Structure (JGJ/T 443-2018) (China), and then 100 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, and demolding was performed after 18 h, and curing by steam was performed for 7d, to obtain a recycled concrete structure layer, which has a size of 2400 mm×900 mm (inner width 780 mm)×240 mm (inner height 120 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 100 g of nano-CaCO₃ (average particle size: 120 nm) and 500 g of sodium polyacrylate were added into 1 kg of water, and then they were processed with a bath-type ultrasonic processor for 2 h (80 W, ultrasonic method: pausing for 10 s every 90 s of ultrasonic processing), to form a nano-CaCO₃ aqueous dispersion.

S22: 100 kg of aluminate-based expansive cement, 1 kg of nano-CaCO₃ aqueous dispersion and 30 kg of water were fully homogenized, to form a nano-modified cement slurry. Meanwhile, 1 kg of chemical foaming agent was dissolved in 4 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A nano-CaCO₃ sol was prepared by a sol-gel method, wherein the mass ratio of nano-CaCO₃ to the nano-CaCO₃ sol was 0.05:1.

S32: 100 g of propyltrimethoxysilane was dissolve in 25 g of a mixed medium of ethanol and water (mass ratio of ethanol to water: 0.5:1). Under catalysis of 5 g of acetic acid and action of 10 g of polyoxyethylene alkylphenyl ether emulsifier, a semitransparent viscous silane polymer sol was formed. Then 100 g of the nano-CaCO₃ sol was mixed with the silane polymer sol by a self-assembly technology to form a composite sol system, so as to form a nano-modified silane.

S33: Two structures for splicing prepared in S2 were spliced by a roll coating method. 2 layers of the nano-modified silane composite sol with a thickness of 480 μm were coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 39.1±5.26 MPa and 0.114±0.011 MPa, respectively. The flexural strength in a three-point-bend test and mid span bending deformation of the reinforced wall of the recycled concrete structure layer were measured by a large-sized test machine. They were 20.13 MPa and 9.08 mm, respectively. The contact angle, dry density, 72h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 29.43°, 297.3 kg/m³, 57.6%, 0.52 MPa and 0.0828 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 114.45° and 12.9%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which substantially met the requirements of the specification, and effectively achieves the effect of recycling of total components of construction waste.

### Example 3

The specific steps of the preparation process of the nano-modified material for cavity wall with insulation for prefabricated building in this Example are as follows.

S1 Preparation of a Recycled Concrete Structure Layer

S11: 1.75 kg melamine resin-based water reducing agent was dissolved in 37.5 kg of water to form a water reducing agent solution.

S12: 350 kg of Portland cement, 1050 kg of recycled coarse aggregate, 455 kg of recycled fine aggregate and 3.5 kg of recycled micro powder are mechanically homogenized according to the Technical Standard for Recycled Concrete Structure (JGJ/T 443-2018) (China), and then 50 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, and demolding was performed after 18 h, and curing by steam was performed for 7d, to obtain a recycled concrete structure layer, which has a size of 1350 mm×630 mm (inner width 560 mm)×180 mm (inner height 60 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 500 g of graphene oxide (average diameter <500 nm, oxygen content: 41-50%) and 1 kg of N-methylpyrrolidone were added into 5 kg of water, and then they were processed with a bath-type ultrasonic processor for 2 h (80 W, ultrasonic method: pausing for 10 s every 90 s of ultrasonic processing), to form a graphene oxide aqueous dispersion.

S22: 100 kg of silicate-based expansive cement, 2 kg of graphene oxide aqueous dispersion and 50 kg of water were fully homogenized, to form a nano-modified cement slurry. Meanwhile, 1 kg of composite foaming agent was dissolved in 24 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A graphene oxide sol was prepared by a sol-gel method, wherein the mass ratio of graphene oxide to the graphene oxide sol was 0.2:1.

S32: 100 g of isobutyl siloxane was dissolve in 40 of a mixed medium of ethanol and water (mass ratio of ethanol to water: 0.6:1). Under catalysis of 5 g of acetic acid and action of 10 g of polyoxyethylene alkylphenyl ether emulsifier, a semitransparent viscous silane polymer sol was formed. Then 350 g of graphene oxide sol was mixed with the silane polymer sol by a self-assembly technology to form a composite sol system, so as to form a nano-modified silane.

S33: Two structures for splicing prepared in S2 were spliced by a roll coating method. 4 layers of the nano-modified silane composite sol with a thickness of 980 μm were coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 46.3±4.95 MPa and 0.128±0.08 MPa, respectively. The flexural strength in a three-point-bend test and mid span bending deformation of the reinforced wall of the recycled concrete structure layer were measured by a large-sized test machine. They were 23.65 MPa and 7.14 mm, respectively. The contact angle, dry density, 72h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 35.17°, 304.1 kg/m³, 42.8%, 0.54 MPa and 0.0805 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 122.39° and 5.8%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which met the requirements of the specification, and effectively achieves the effect of recycling of total components of construction waste.

### Example 4

The specific steps of the preparation process of the nano-modified material for cavity wall with insulation for prefabricated building in this Example are as follows.

S1 Preparation of a Recycled Concrete Structure Layer

S11: 3.5 kg of polycarboxylic acid-based water reducing agent was dissolved in 40 kg of water to form a water reducing agent solution.

S12: 350 kg of P.O. 42.5R ordinary Portland cement, 350 kg of recycled coarse aggregate and 525 kg of recycled fine aggregate are mechanically homogenized according to the Technical Standard for Recycled Concrete Structure (JGJ/T 443-2018) (China), and then 100 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, and demolding was performed after 18 h, and curing by steam was performed for 7d, to obtain a recycled concrete structure layer, which has a size of 2100 mm×800 mm (inner width 700 mm)×210 mm (inner height 110 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 500 g of nano-TiO₂ (average particle size: 200 nm) and 50 g of cetyltrimethylammonium bromide were added into 0.5 kg of water, and then they were processed with a bath-type ultrasonic processor for 2 h (80 W, ultrasonic method: pausing for 10 s every 90 s of ultrasonic processing), to form a nano-TiO₂ aqueous dispersion.

S22: 50 kg of sulphoaluminate-based expansive cement, 0.5 kg of nano-TiO₂ aqueous dispersion and 15 kg of water were fully homogenized, to form a nano-modified cement slurry. Meanwhile, 1 kg of plant protein-based foaming fluid was dissolved in 9 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A nano-TiO₂ sol was prepared by a sol-gel method.

S32: 100 g of hexamethyldisiloxane was dissolve in 50 g of a mixed medium of ethanol and water (mass ratio of ethanol to water: 4:10). Under catalysis of 50 g of acetic acid and action of 10 g of polyoxyethylene alkylphenyl ether emulsifier, a semitransparent viscous silane polymer sol was formed. Then 200 g of the nano-TiO₂ sol was mixed with the silane polymer sol by a self-assembly technology to form a composite sol system, so as to form a nano-modified silane.

S33: Two structures for splicing prepared in S2 were spliced by a roll coating method. 1 layer of the nano-modified silane composite sol with a thickness of 50 μm was coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 39.1±5.26 MPa and 0.114±0.011 MPa, respectively. The flexural strength in a three-point-bend test and mid span bending deformation of the reinforced wall of the recycled concrete structure layer were measured by a large-sized test machine. They were 22.87 MPa and 6.98 mm, respectively. The contact angle, dry density, 72 h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 43.25°, 284.5 kg/m³, 45.7%, 0.49 MPa, 0.0797 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 109.24° and 10.3%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which met the requirements of the specification, and effectively achieves the effect of recycling of total components of construction waste.

### Example 5

The specific steps of the preparation process of the nano-modified material for cavity wall with insulation for prefabricated building in this Example are as follows.

S1 Preparation of a Recycled Concrete Structure Layer

S11: 7 kg of sodium naphthalene sulfonate water reducing agent was dissolved in 55 kg of water to form a water reducing agent solution.

S12: 350 kg of Portland cement, 1225 kg of recycled coarse aggregate, 437.5 kg of recycled fine aggregate and 7 kg of recycled micro powder are mechanically homogenized according to the Technical Standard for Recycled Concrete Structure (JGJ/T 443-2018) (China), and then 50 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, in which the mold cavity has a size of 1850 mm×1350 mm (inner width 1300 mm)×115 mm (inner height 85 mm), and demolding was performed after 18 h, and curing by steam was performed for 7d, to obtain a recycled concrete structure layer, which has a size of 2000 mm×780 mm (inner width 680 mm)×180 mm (inner height 80 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 1 kg of carbon nanotubes (CNT, diameter 20-40 nm, length 5-15 μm) and 800 g of sodium p-styrenesulfonate were added into 3 kg of water, and then they were processed with a bath-type ultrasonic processor for 2 h (80 W, ultrasonic method: pausing for 10 s every 90 s of ultrasonic processing), to form a CNT aqueous dispersion.

S22: 100 kg of aluminate-based expansive cement, 4 kg of CNT aqueous dispersion and 30 kg of water were fully homogenized, to form a nano-modified cement slurry. Meanwhile, 1 kg of animal protein-based foaming fluid was dissolved in 4 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry, wherein the mass ratio of the nano-modified cement slurry to the foam was 1:0.15.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A CNT sol was prepared by a hydrothermal method, wherein the mass ratio of CNT to the CNT sol was 1:1.

S32: 200 g of cyclomethylsiloxane was dissolve in 60 g of a mixed medium of ethanol and water (mass ratio of ethanol to water: 0.6:1). Under catalysis of 50 g of acetic acid and action of 30 g of polyoxyethylene alkylphenyl ether emulsifier, a semitransparent viscous silane polymer sol was formed. Then 600 g of the CNT sol was mixed with the silane polymer sol by a self-assembly technology to form a composite sol system, so as to form a nano-modified silane.

S33: Two structures for splicing prepared in S2 were spliced by a roll coating method. 5 layers of the nano-modified silane composite sol with a thickness of 1000 wri were coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 41.3±4.90 MPa and 0.122±0.09 MPa, respectively. The flexural strength in a three-point-bend test and mid span bending deformation of the reinforced wall of the recycled concrete structure layer were measured by a large-sized test machine. They were 23.45 MPa and 7.06 mm, respectively. The contact angle, dry density, 72 h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 39.42°, 301.5 kg/m³, 43.1%, 0.53 MPa, 0.0811 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 132.46° and 3.9%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which met the requirements of the specification, and effectively achieves the effect of recycling of total components of construction waste.

### Example 6

The specific steps of the preparation process of the nano-modified material for cavity wall with insulation for prefabricated building in this Example are as follows.

S1 Preparation of a Recycled Concrete Structure Layer

S11: 10.5 kg of melamine resin-based water reducing agent was dissolved in 75 kg of water to form a water reducing agent solution.

S12: 350 kg of composite cement, 350 kg of recycled coarse aggregate, 420 kg of recycled fine aggregate and 10.5 kg of recycled micro powder are mechanically homogenized according to the Technical Standard for Recycled Concrete Structure (JGJ/T 443-2018) (China), and then 100 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, and demolding was performed after 18 h, and curing by steam was performed for 7d, to obtain a recycled concrete structure layer, which has a size of 1450 mm×660 mm (inner width 580 mm)×180 mm (inner height 80 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 240 g of nano-ZnO (average particle size: 120 nm) and 240 g of sodium p-styrenesulfonate were added into 1.5 kg of water, and then they were processed with a bath-type ultrasonic processor for 2 h (80 W, ultrasonic method: pausing for 10 s every 90 s of ultrasonic processing), to form a nano-ZnO aqueous dispersion.

S22: 40 kg of silicate-based expansive cement, 2 kg of nano-ZnO aqueous dispersion and 20 kg of water were fully homogenized, to form a nano-modified cement slurry. Meanwhile, 1 kg of chemical foaming agent was dissolved in 1 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry, wherein the mass ratio of the nano-modified cement slurry to the foam was 1:0.15.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A nano-ZnO sol was prepared by a sol-gel method, wherein the mass ratio of nano-ZnO to the nano-ZnO sol was 0.2:1.

S32: 50 g of cyclomethylsiloxane was dissolve in 12.5 g of a mixed medium of ethanol and water (mass ratio of ethanol to water: 0.5:1). Under catalysis of 5 g of acetic acid and action of 5 g of polyoxyethylene alkylphenyl ether emulsifier, a semitransparent viscous silane polymer sol was formed. Then 100 g of the nano-ZnO sol was mixed with the silane polymer sol by a self-assembly technology to form a composite sol system, so as to form a nano-modified silane.

S33: Two structures for splicing prepared in S2 were spliced by a roll coating method. 3 layers of the nano-modified silane composite sol with a thickness of 850 μm were coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 37.4±4.76 MPa and 0.094±0.007 MPa, respectively. The flexural strength in a three-point-bend test and mid span bending deformation of the reinforced wall of the recycled concrete structure layer were measured by a large-sized test machine. They were 21.86 MPa and 6.83 mm, respectively. The contact angle, dry density, 72h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 29.78°, 319.2 kg/m³, 46.2%, 0.51 MPa, 0.0827 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 111.67° and 12.3%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which met the requirements of the specification, and effectively achieves the effect of recycling of total components of construction waste.

### Example 7

The specific steps of the preparation process of the nano-modified material for cavity wall with insulation for prefabricated building in this Example are as follows.

S1 Preparation of a Recycled Concrete Structure Layer

S11: 14 kg of polycarboxylic acid-based water reducing agent was dissolved in 92.5 kg of water to form a water reducing agent solution.

S12: 350 kg of Portland cement, 700 kg of recycled coarse aggregate, 490 kg of recycled fine aggregate and 14 kg of recycled micro powder are mechanically homogenized according to the Technical Standard for Recycled Concrete Structure (JGJ/T 443-2018) (China), and then 100 kg of water was added thereto and they are blended uniformly, so as to form a mixture.

S13: The water reducing agent solution was added to the mixture mentioned-above, and the mixture was further stirred, to form a recycled concrete slurry.

S14: The recycled concrete slurry was cast into a mold purpose-built for a wall panel structure layer for prefabrication, and demolding was performed after 18 h, and curing by steam was performed for 7d, to obtain a recycled concrete structure layer, which has a size of 2250 mm×900 mm (inner width 800 mm)×210 mm (inner height 110 mm). Meanwhile, a part of the recycled concrete slurry was cast into a 100 mm³ cubic steel formwork, to make a 100 mm³ cubic concrete sample for measuring the compressive strength of the concrete material.

S2 Preparation of a Nano-Modified Foam Concrete Thermal Insulation Core Layer

S21: 600 g of nano-Fe₂O₃ (average particle size: 120 nm) and 600 g of sodium dodecylbenzene sulfonate were added into 5 kg of water, and then they were processed with a bath-type ultrasonic processor for 2 h (80 W, ultrasonic method: pausing for 10 s every 90 s of ultrasonic processing), to form a nano-Fe₂O₃ aqueous dispersion.

S22: 100 kg of sulphoaluminate-based expansive cement, 5 kg of nano-Fe₂O₃ aqueous dispersion and 50 kg of water were fully homogenized, to form a nano-modified cement slurry. Meanwhile, 1 kg of composite foaming agent was dissolved in 4 kg of water, and then it was foamed by a foam concrete foaming machine, to obtain a foam.

S23: The obtained foam was mixed into the nano-modified cement slurry by a foam concrete stirrer slowly and gently, to form a nano-modified foam concrete slurry, wherein the mass ratio of the nano-modified cement slurry to the foam was 1:0.15.

S24: The nano-modified foam concrete slurry was pumped to the inner core layer of the obtained recycled concrete structure layer by a foam concrete pumping equipment, and was cured for 3d, so as to obtain a nano-modified foam concrete thermal insulation core layer. Meanwhile, the nano-modified foam concrete slurry was cast into a 100 mm³ cubic test mold, a 300 mm×300 mm×35 mm plate test mold, and a 40 mm×40 mm×5 mm cuboid test mold on a recycled concrete substrate plate made in the S1 step. The physical properties of the samples, involving dry density, water absorption, compressive strength, thermal conductivity, and bond strength to the recycled concrete structure layer, were tested.

S3 Preparation of Nano-Modified Silane Waterproof Coating

S31: A nano-Fe₂O₃ sol was prepared by a sol-gel method, wherein the mass ratio of nano-Fe₂O₃ to the nano-Fe₂O₃ sol was 0.1:1.

S32: 200 g of methyltriethoxysilane was dissolve in 50 g of a mixed medium of ethanol and water (mass ratio of ethanol to water: 0.4:1). Under catalysis of 10 g of acetic acid and action of 20 g of polyoxyethylene alkylphenyl ether emulsifier, a semitransparent viscous silane polymer sol was formed. Then 400 g of the nano-Fe₂O₃ sol was mixed with the silane polymer sol by a self-assembly technology to form a composite sol system, so as to form a nano-modified silane.

S33: Two structures for splicing prepared in S2 were spliced by a roll coating method. 3 layers of the nano-modified silane composite sol with a thickness of 850 μm were coated at the butt joint. After curing, a nano-modified silane waterproof coating was formed. Meanwhile, the nano-modified silane composite sol was coated at the butt joint of 2 pieces of samples prepared in S2 by the same coating process. The contact angle and water absorption rate of the nano-modified silane waterproof coating on the nano-modified foam concrete thermal insulation core layer were tested.

The 28d cube compressive strength of a recycled concrete structure layer specimen and the bond strength between the two structure layers of the specimens of the nano-modified foam concrete thermal insulation core layer—recycled concrete structure layer were measured by a universal material testing machine. They were 39.3±4.15 MPa and 0.109±0.008 MPa, respectively. The flexural strength in a three-point-bend test and mid span bending deformation of the reinforced wall of the recycled concrete structure layer were measured by a large-sized test machine. They were 22.76 MPa and 7.01 mm, respectively. The contact angle, dry density, 72 h water absorption in volume, compressive strength and thermal conductivity of the nano-modified foam concrete thermal insulation core layer were measured by a contact angle apparatus, a drying weighing method, a double-side water absorption method, an axial compression method and a plate heat conduction method, respectively. They were 32.06°, 325.8 kg/m³, 51.6%, 0.49 MPa, 0.0820 W/m·K, respectively. The contact angle and 72 h water absorption in volume of the nano-modified foam concrete thermal insulation core layer coated by a nano-modified silane waterproof coating were measured by a contact angle apparatus and a double-side water absorption method, respectively. They were 114.22° and 11.3%, respectively.

The recycled concrete structure layer, the nano-modified foam concrete thermal insulation core layer and the nano-modified silane waterproof coating were quickly assembled into a nano-modified material for cavity wall with insulation, and the material was successfully applied to practical prefabricated building projects. The overall strength, deformation capacity, interface hydrophobicity effect and thermal performance effect were good, which met the requirements of the specification, and effectively achieves the effect of recycling of total components of construction waste.

### Example 8

The preparation method of this example was the same as that of example 7, except that in step S3, screen printing technology was used as the coating process of the nano-modified silane waterproof coating.

The contact angle and 72 h water absorption in volume of the nano-modified foam concrete thermal insulation core layer coated with the silane waterproof coating by the screen printing technology were measured by a contact angle apparatus and a double-side water absorption method, respectively. They were 117.42° and 9.5% respectively. The corresponding interface hydrophobicity effect also met the requirements.

The test results of the Examples 1-8 sufficiently show that in the nano-modified material for cavity wall with insulations for prefabricated building produced by the present disclosure, the nano-modified foam concrete thermal insulation core layer has small dry density and low thermal conductivity, indicating that the nano-modified foam concrete thermal insulation core layer has the characteristics of light weight and heat preservation. It may be combined with the recycled concrete structure layer to achieve a wall material with integrated structural properties and thermal insulation properties. Compared with the nano-modified foam concrete thermal insulation core layer without a nano-modified silane waterproof coating, after a nano-modified silane waterproof coating was coated, the contact angle was obviously increased and the water absorption was decreased significantly, indicating that the nano-modified silane waterproof coating may significantly improve the hydrophobic and waterproof effects of the nano-modified foam concrete thermal insulation core layer.

The nano-modified material for cavity wall with insulation for prefabricated building of the present disclosure may effectively guarantee the light weight and heat preservation effect of the core layer, the strong interface adhesion with the base surface, and the effect of greatly reducing the water absorption of the wall material interface. Finally, it may achieve the recycling of total components of construction waste, which possesses huge economic and environmental benefits.

The products are classified in terms of the mechanical property indexes, such as the compressive strength, flexural strength in three-point-bend, the mid span bending deformation, of the concrete in recycled concrete structure layer, indexes, such as the dry density, water absorption in volume, compressive strength and thermal conductivity, of the nano-modified foam concrete thermal insulation core layer, and the influence of the nano-modified silane waterproof coating on the contact angle and water absorption of the nano-modified foam concrete thermal insulation core layer, respectively. The above-mentioned three aspects are optimized in teams effectively for specific projects. Finally, it is applied to the thermal insulation integrated panel system for prefabricated building structure, to realize the scale application of nano-modified material for cavity wall with insulation.

The beneficial effects of the present disclosure include followings.

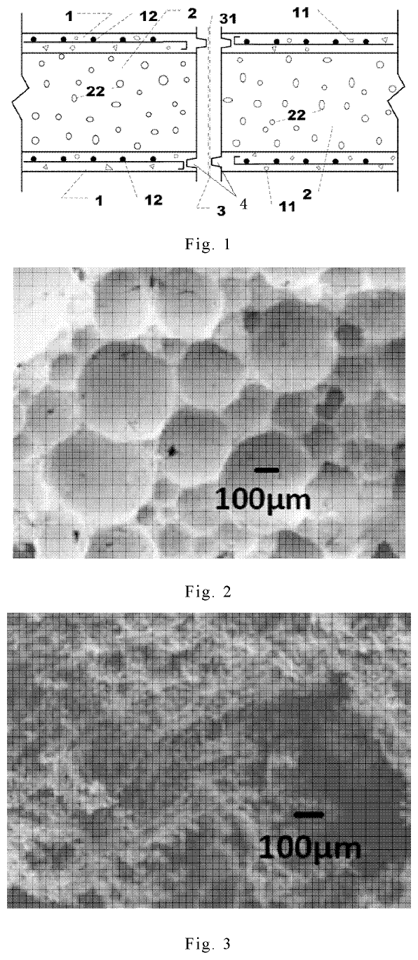

1. By adopting the nano-modified material for cavity wall with insulation for prefabricated building and the preparation process of the present disclosure, not only a thermal insulation integrated panel system for prefabricated building structure may be rapidly formed, but also the light weight and heat preservation effect of the core layer and the interface adhesion with the base surface may be effectively guaranteed. As shown in FIGS. 2 and 3, the nano-modified foam concrete thermal insulation core layer of the present disclosure has uniform round foam and uniform pore size and obvious honeycomb structure, reflecting that the foam concrete core layer reinforced by expansive cement and nanomaterials does not exhibit the phenomenon of poor slurry stability, collapse in mold, and shrinkage and cracking on the surface. On the contrary, the foam concrete based on ordinary silicate cement exhibits poor slurry stability, serious collapse in mold, and shrinkage and cracking on the surface. The water absorption of the wall material interface is greatly reduced, and the recycling of construction waste is realized, which contains huge economic and environmental benefits.

2. The panel of the present disclosure has high surface compressive strength, low overall water absorption and low thermal conductivity, and more than 50% of the materials used for the whole panel are recycled materials. It is a novel wall material really with energy conservation and environmental protection properties. The wall material may effectively replace the existing wall material, save cost, and has good moisture-proof and mildew-proof performance, excellent heat preservation and insulation performance. It may be used in the environment with bad climate and large temperature difference, without deformation, embrittlement and with stable performance.

3. In the wall panel of the present disclosure, on the one hand, the use of expansive cement makes the nano-modified foam concrete thermal insulation core layer have a certain degree of micro expansion. When it is pumped into the recycled concrete structure layer, it may enhance the interfacial bonding property between the nano-modified foam concrete thermal insulation core layer and the recycled concrete structure layer, so that it is difficult to occur that two layers delaminate from each other when used. On the other hand, expansive cement has the characteristics of fast setting and fast strength growth, which may quickly seal the microbubbles and effectively improve the integrity and survival rate of the microbubbles. Nanomaterial has high specific surface area, large number of tangling bonds and unique nanosize effect, thereby may form a large number of foaming cores around the microbubbles, and thus enhancing the surface tension of the foams, thus effectively solving the problem of foam collapse in the existing cement foam wall panels.

Although the present disclosure is described in detail by referring to the accompanying drawings and in combination with preferred Examples, the present disclosure is not limited thereto. Without departing from the spirit and substance of the present disclosure, those skilled in the art may make various equivalent modifications or replacements to the embodiments of the present disclosure, which should be within the scope of the present disclosure. Therefore, the protection scope of the present disclosure shall be subject to the protection scope of the claims.

1. A nano-modified material for cavity wall with insulation for prefabricated building, comprising splicing structures and a nano-modified silane waterproof coating,
wherein the splicing structure comprises a recycled concrete structure layer and a nano-modified foam concrete thermal insulation core layer, the recycled concrete structure layer is a hollow cuboid structure with openings at both ends, the nano-modified foam concrete thermal insulation core layer is a structure formed by casting inside the recycled concrete structure layer, and the nano-modified silane waterproof coating is applied at a butt joint of two of the splicing structures;
wherein the recycled concrete structure layer comprises following components: a cement, a recycled coarse aggregate, a recycled fine aggregate, a recycled micro powder, a water reducing agent, and water, and a mass ratio of respective components is 1:(1-3.5):(1-1.5):(0-0.05):(0.005-0.05):(0.25-0.55);
wherein the nano-modified foam concrete thermal insulation core layer comprises following components: an expansive cement, a foam obtained by foaming of a foaming fluid formulated at a standard concentration, a nanomaterial-containing nanomaterial aqueous dispersing fluid, a surfactant, and water, and a mass ratio of respective components is 1:(0.05-0.25):(0.01-0.05):(0.001-0.01):(0.3-0.5), and a mass ratio of the nanomaterial aqueous dispersing fluid to the nanomaterial is (0.01-0.05):(0.001-0.01); and
wherein the nano-modified silane waterproof coating comprises following components: a silane monomer, an emulsifier, a mixed medium of ethanol and water, and a nanomaterial sol, and a mass ratio of respective components is 1:(0.1-0.15):(0.25-0.55):(1-3.5).

2. The nano-modified material for cavity wall with insulation for prefabricated building according to claim 1, wherein a mass ratio of the recycled concrete structure layer, the nano-modified foam concrete thermal insulation core layer and the nano-modified silane waterproof coating is 100:(5-10):(0.01-0.1).

3. The nano-modified material for cavity wall with insulation for prefabricated building according to claim 1, wherein the cement is a Portland cement, an ordinary Portland cement or a composite cement; the water reducing agent is a polycarboxylic acid-based water reducing agent, a naphthalene-based sodium sulfonate water reducing agent or a melamine resin-based water reducing agent; the expansive cement is one of a sulphoaluminate-based expansive cement, an aluminate-based expansive cement and a silicate-based expansive cement; the foaming fluid is one of an animal protein foaming agent, a plant protein foaming agent, a chemical foaming agent and a composite foaming agent; the nanomaterial is one of nano-SiO₂, nano-TiO₂, nano-ZnO, nano-Fe₂O₃, nano-CaCO₃, carbon nanotubes and graphene oxide; and the surfactant is one of sodium dodecylbenzene sulfonate, cetyltrimethylammonium bromide, sodium polyacrylate, sodium p-styrenesulfonate and N-methylpyrrolidone.

4. The nano-modified material for cavity wall with insulation for prefabricated building according to claim 1, wherein the silane monomer is methyltriethoxysilane, propyltrimethoxysilane, isobutyl siloxane, hexamethyldisiloxane or cyclomethylsiloxane; the emulsifier is polyoxyethylene alkylphenyl ether, polyoxyethylene trimethylnonyl ether copolymer or polyoxyethylene octylphenol ether; a mass ratio of ethanol and water is (0.4-0.6):1 in the mixed medium of ethanol and water; and a mass ratio of the nanomaterial to the nanomaterial sol is (0.05-0.2):1 in the nanomaterial sol.

5. A preparation method of the nano-modified material for cavity wall with insulation for prefabricated building according to claim 1, comprising following steps:
S1 Preparation of the recycled concrete structure layer:
S11: dissolving the water reducing agent in a part of the water, to form a water reducing agent solution;
S12: mixing the cement, the recycled coarse aggregate, the recycled fine aggregate, the recycled micro powder and remaining water mechanically, to form a mixture;
S13: adding the water reducing agent solution to the mixture, and further stirring the mixture, to form a recycled concrete slurry;
S14: casting the recycled concrete slurry into a special mold for prefabricated wall panel structural layer, and obtaining the hollow recycled concrete structural layer by steam curing and molding and demolding;
S2 Preparation of the nano-modified foam concrete thermal insulation core layer:
S21: dispersing the nanomaterial and the surfactant in water, to form an aqueous dispersion of nanomaterial;
S22: mixing the expansive cement, the aqueous dispersion of nanomaterial and water sufficiently uniformly, to form a nano-modified cement slurry; meanwhile, obtaining the foam by foaming of a foaming fluid formulated at a standard concentration with a physical foaming method;
S23: mixing uniformly the nano-modified cement slurry and the foam uniformly, to obtain a nano-modified foam concrete slurry by a foam concrete mixer;
S24: pumping the nano-modified foam concrete slurry to a hollow inner core layer of the recycled concrete structure layer by a foam concrete pumping equipment, and performing curing and molding, to obtain the nano-modified foam concrete insulation core layer, to obtain the splicing structure;
S3 Preparation of the nano-modified silane waterproof coating:
S31: preparing the nanomaterial sol;
S32: preparing a silane polymer sol from the silane monomer, the emulsifier, ethanol and water, mixing the nanomaterial sol with the silane polymer sol to form a composite sol system, in which nano-modified silane is formed by modifying a surface of the nanomaterial by silane polymer;
S33: splicing two splicing structures prepared in S2, and applying nano-modified silane at the butt joint, and forming the nano-modified silane waterproof coating by curing.

6. The preparation method according to claim 5, wherein in step S14, the special mold for prefabricated wall panel structural layer is a hollow cuboid steel mold equipped with a reinforcing steel bar mesh, and is characterized by being double-layer hollow, wherein an inner hollow cuboid steel mold is nested in an outer hollow cuboid steel mold, and the recycled concrete slurry is casted into the outer hollow cuboid steel mold equipped with the reinforcing mesh, and the inner hollow cuboid steel mold is removed, to form the hollow recycled concrete structure layer; wherein the recycled concrete structure layer has an inner height of 60-120 mm, an outer height of 180-240 mm, an inner width of 550-850 mm, an outer width of 600-900 mm, and a length of 1350-2400 mm.

7. The preparation method according to claim 5, wherein the special mold for prefabricated wall panel structural layer is provided with “convex concave” female-male connection ends in a width direction.

8. The preparation method according to claim 5, wherein in step S23, a mass ratio of the nano-modified cement slurry to the foam is 1:(0.03-0.17) in the nano-modified foam concrete slurry.

9. The preparation method according to claim 5, wherein in step S33, the nano-modified silane waterproof coating layer is formed by performing coating 1-5 times, and a thickness formed by coating at each time is 50 μm-1000 μm.

10. A method comprising applying a nano-modified material for cavity wall with insulation for prefabricated building according to claim 1, wherein the nano-modified material for cavity wall with insulation for prefabricated building is used as a structure-thermal insulation-integrated wall for a prefabricated building.
